(19) United States
(12) Patent Application Publication
(10) Pub. No.: US 2024/0354370 A1
(43) Pub. Date: Oct. 24, 2024

(54) Change Point Determination

(71) Applicant: SAP SE, Walldorf (DE)

(72) Inventors: Dominic Hehn, Speyer (DE); Florian Knoerzer, Neunkirchen (DE); Swen Koenig, Schwetzingen (DE); Jocelyn Borella, Karlsruhe (DE); Mustafa Aktan, Wiesloch (DE); Naseer Muhammad, Bad Hersfeld (DE)

(21) Appl. No.: 18/305,591

(22) Filed: Apr. 24, 2023

(51) Int. Cl. G06F 17/18

(52) U.S. Cl. CPC G06F 17/18

(57) ABSTRACT

Embodiments determine change points within received time series data exhibiting a natural trend. A first candidate change point comprising an earlier time and a first value, and a second candidate change point comprising a later time and a second value, are received with the time series data. A rule is executed upon the first candidate change point to calculate a first score, and executed upon the second candidate change point to calculate a second score. The rule comprises a primary criterion for a change direction relative to the natural trend, a secondary criterion for a change position within the time series data, and a tertiary criterion for a change magnitude. The first score is compared to the second score to select the first candidate change point or the second candidate change point as a determined change point. The determined change point is stored for use in subsequent data analysis.

### BACKGROUND

Unless otherwise indicated herein, the approaches described in this section are not prior art to the claims in this application and are not admitted to be prior art by inclusion in this section.

Time series data may be collected for a variety of purposes. One possible example could be collecting heart rate data for a medical patient over time.

In general, change points indicate an abrupt change or anomaly in time series data. Accurate detection of such change points may be important. For example, an abrupt change in heart rate data could trigger the need for active medical intervention in order to save a patient's life.

### SUMMARY

Embodiments relate to systems and methods of determining change points within incoming time series data. The time series data exhibiting a natural trend (e.g. up or down) is received. A first candidate change point comprising an earlier time and a first value, and a second candidate change point comprising a later time and a second value are also received as input. A rule is executed upon the first candidate change point to calculate a first score, and executed upon the second candidate change point to calculate a second score. The rule comprises a primary criterion for a change direction relative to the natural trend, a secondary criterion for a change position within the time series data, and a tertiary criterion for a change magnitude. The first score is compared to the second score to select the first candidate change point or the second candidate change point as a determined change point. The determined change point is then stored in a non-transitory computer readable storage medium for reference in connection with further analysis of the time series data.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified plot of time series data according to an example.

FIG. 4 shows a simplified flow according to the example.

FIG. 5 shows identification of candidate change points according to the example.

FIG. 6 shows as derivation stage according to the example.

FIGS. 7A-B shows a clustering stage according to the example.

FIGS. 8-10 show plots with different change point determinations in the example

FIG. 11 shows an overview of an architecture utilized to implement the example.

FIG. 12 shows a data flow and sequence diagram according to the example.

FIG. 13 shows an activity diagram for the example.

FIG. 14 shows a delta load state diagram according to the example.

FIG. 15 illustrates hardware of a special purpose computing machine configured to implement change point determination according to an example.

FIG. 16 illustrates an example computer system.

### DETAILED DESCRIPTION

Described herein are methods and apparatuses that implement change point determination. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

Time series data may be collected for a variety of purposes. Capacity metrics may be valuable for use cases such as problem analysis or planning of future activities.

The values of capacity metrics have a fixed value range, typically from empty to full. Examples of a capacity can include but are not limited to:
amount of milk in a fridge
# of records in a database table
amount of fuel in a tank
many, many others.

When the environmental conditions are more or less constant, a shape of a time series may be quite smooth, e.g. in the case of:
a consumer of one cup milk per breakfast
normal usage of an application which writes N record into a database table per day
a same driver who drives the same route every day

Under such conditions, an extrapolation of existing time series data can be used to predict a capacity metric (e.g., the day when there is no more milk in the fridge.) This is true when the extrapolation reaches a given limit (“empty”).

However, environmental conditions may not be relatively constant. Irregularities can occur, causing changes (change points) in the shape of the time series. Examples of such time points can include but are not limited to:
no milk is consumed during a vacation away from home
after an upgrade the write to database behavior of an application changed
a different driver uses the car.

Change point detection in the shape of the time series, can be used to obtain the time when an irregularity occurred. The detection of change points in a time series is useful for many valuable tasks.
For problem/root cause analysis, change points indicate a time when something unknown happened. With these times, one can search for events that occurred at the same time.
For purposes of prediction, when the distance between change points follows a predictable rule (like equidistant as simplest), it is possible to predict future change points.
For advanced predictions, change points can help to improve the accuracy of extrapolations.

For analyzing time series in connection with capacity metrics, it makes sense to distinguish between the direction of change at a change point. Specifically, capacity metrics exhibit a trend of a natural direction over time, e.g.:
increasing values in the case of a number of records in a database table;
decreasing values in the case of a level of fuel level in a tank;
decreasing values in the case of a number of milk bottles in the fridge.

Changes in time series data trending against this natural direction are relatively rare. Such changes may be indicative of the occurrence of a relatively significant event, e.g.:
a trip to the store to buy new milk.
the database administrator executed an archiving job to reduce table size;
the car user encountering low price at the fuel station to prompt tank filling;

Changes that occur prior to an irregular change may be less relevant. This is true even when such previous changes are of a large magnitude.

However, a position of a change point within the time series, and the change itself may also be important considerations for relevance. Later change points may be more relevant than earlier ones; larger changes may be more relevant than smaller changes which occur closer to the noise level.

For change point detection according to embodiments, at least these properties of potential change points are used to calculate a score value. The highest score value indicates the most relevant change.

The following are three (3) possible examples of score calculation, with:
w₁, w₂, and w₃=weighting parameters with w₃>w₂.
t_{now}=the current time
t=time (x axis)
abs( )=absolute value
y′(t)=first derivation of the value at time t, calculated as difference between adjacent values in a time series, e.g.: With y=(8, 5, 1, 10, 12, 8, 4, 2) the values of y′ are (3, 4, −9, −2, 4, 4, 2); y′ thus describes how the values in y have changed.
1) score=w₁*(t_{now}−t)+w₂*abs (y′(t)), when change has regular direction;
2) score=w₁*(t_{now}−t)+w₃*abs (y′(t)), when change has irregular direction;
3) score=0; when there is a later irregular change point.

Score calculation may use functions (e.g. square, log, . . . ) to amplify or reduce the effect of the criteria values. One possible example is:

$$\\ score = {w}_{1} * {( {t}_{now} - t )}^{2} + {w}_{2} * log ( abs ( {y}^{{}_{} ′} ( t ) ) )$$

The weighting parameters w₁, w₂ and w₃ can be estimated via a hyperparameter optimization. This allows to apply this method to many different types of capacity values.

The hyperparameter optimization may involve a set of time series where the best change point is already known (e.g., selected manually by a human expert.) In the milk consumption example, this may utilize data from multiple different households, with an expert labeling a most relevant change point in each data set.

Once the labelled data are ready, a computer runs the change point detection with many combinations of w₁, w₂, w₃ for all time series. Example:
1^{st} run: w₁=1, w₂=1, w₃=1; for 10% of the time series, the procedure detected the labelled change point;
2^{nd} run: w₁=1, w₂=1, w₃=2; for 12% of the time series, the procedure detected the labelled change point;
. . .
216th run: w₁=3, w₂=5.5, w₃=2.5; for 89% of the time series, the procedure detected the labelled change point
. . .
27000th run with w₁=10, w₂=10, w₃=10; for 3% of the time series, the procedure detected the labelled change point

Here, the 89% from the 216th run was the maximum. The corresponding w-values are the result of the optimization. Thus by trying, we can determine a combination of w₁, w₂, w₃ for use as an accurate change point detection for future time series data.

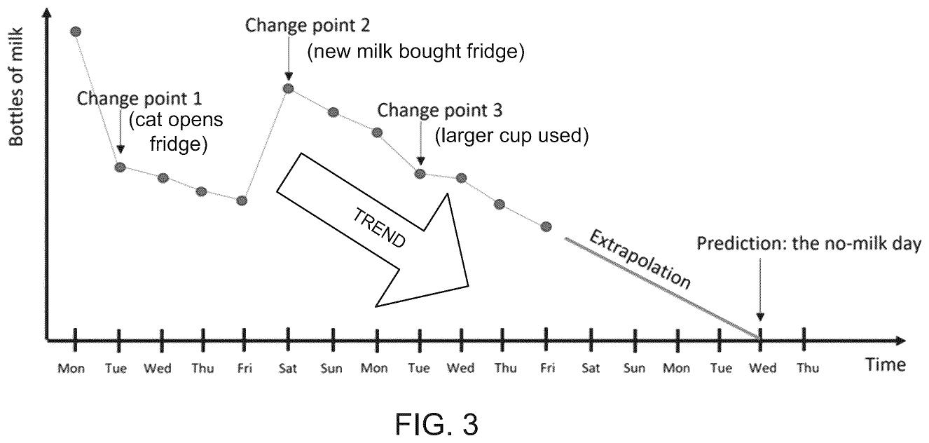

FIG. 3 shows a simplified milk consumption example. Here, it is assumed that parameter optimization has already been performed. It is also assumed that the set of labelled time series contained data similar to the example (ensuring a suitable w₁, w₂, w₃ are obtained).

FIG. 3 shows three possible change points. Applying the above rules, produces the following result.
Change point 1 (the cat managed to open the fridge) is a very big change. But, it occurs before a change in an irregular direction (change point 2) and hence is not relevant.
Change point 3 (used a larger cup than usual) has a position closest to “now”. But the magnitude of the change itself is small.
Change point 2 (bought new milk) has an irregular direction. Therefore, it is the best choice for the most relevant change point.

Thus, with input time series data of metrics representing a capacity, embodiments apply the following criteria (in the order of relevance listed), to calculate a score value:
1) direction of the change
2) position of the change
3) absolute value of the change
   The change point with the highest score value is the “best” change point.

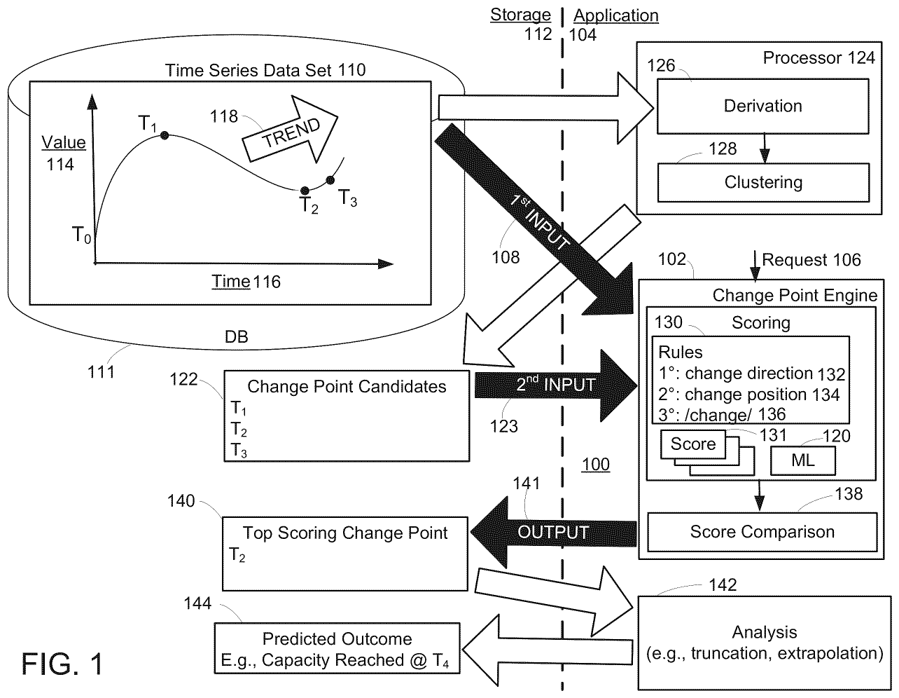

FIG. 1 shows a simplified view of an example system that is configured to implement change point determination according to an embodiment. Specifically, system 100 comprises a change point engine 102 located in an application layer 104.

In response to a request 106, the change point engine receives two inputs. A first input 108 is a time series data set 110 that is present in a non-transitory computer readable storage medium 111 (e.g., database) of a storage layer 112. The time series data set comprises values 114 and corresponding times 116.

The values over time exhibit a natural trend 118. In some embodiments the trend may be a decrease in values over time. An example of such a trend may be where depletion from a state is occurring. Such an embodiment is described below in the highly simplified context of milk being removed from a refrigerator.

By contrast, as specifically depicted in FIG. 1, for some embodiments the trend may be an increase in values over time. An example of such a trend could be where values are rising to eventually reach a capacity. An example is described below, where a number of entries in a database table increases over time to eventually reach a maximum capacity.

Moreover, in still other embodiments, the trend may be more complex. Such a trend may be cyclical and/or obey a historically observed profile (e.g., comprising different distinct states) that could be reflected in a training corpus used for machine learning (ML) 120.

A set of change point candidates 122 is a second input 123 to the change point engine. These change point candidates may be the product of separate processing of the time series data by a processor 124. As is described in detail in the example, such separate processing can comprise derivation 126 and clustering 128.

The change point engine then executes a set of rules 130 upon the two inputs. Operation of these rules results in the assignment of a corresponding score 131 for each of the change point candidates.

The rules may dictate applying scoring criteria according to the following priority:
1° priority: direction 132 of candidate change point relative to trend
2° priority: position 134 of candidate change point in the time series
3° priority: magnitude 136 of change of the candidate change point.

Following scoring, the change point candidates are compared 138 by the change point engine. The candidate change point 140 having the highest score is selected and output 141 for storage.

Having selected the change point, subsequent processing in the application layer may be performed for analysis 142. As is discussed below, such analysis can involve disregarding time series data prior to the selected change point, and then using the remaining time series data to more accurately forecast a predicted outcome 144.

While the particular embodiment of FIG. 1 shows the analysis as being performed downstream of the change point engine, this is not required. Alternative embodiments could have the analysis being performed by the change point engine itself.

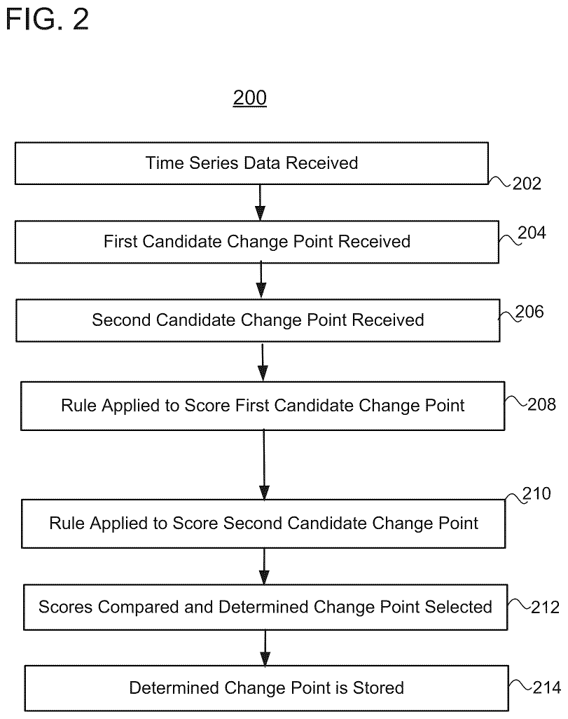

FIG. 2 is a flow diagram of a method 200 according to an embodiment. At 202, time series data exhibiting a natural trend is received.

At 204, a first candidate change point in the time series data is received. At 206, a second candidate change point in the time series data is received.

At 208. a rule is executed upon the first candidate change point to calculate a first score. At 210, the rule is executed upon the second candidate change point to calculate a second score.

At 212, the first score is compared to the second score to select the first candidate change point or the second candidate change point as a determined change point.

At 214, the determined change point is stored in a non-transitory computer readable storage medium for later reference (e.g., during subsequent extrapolation and/or forecasting).

Embodiments as described herein may offer one or more advantages. One potential benefit is improved performance. That is, by selecting one determined change point from a pool of candidates, subsequent analysis (e.g., forecasting and prediction) efforts based upon that one change point can be performed. Rather than having to based prediction upon a suite or pool of candidate change points, (processing/memory/bandwidth) resources are conserved.

Another possible benefit is the conservation of memory resources. That is, time series data that precedes a determined change point may be deemed less important for subsequent analysis, and may be stored (if at all) with less than its full granularity. This may free up the memory to store additional (e.g., voluminous) incoming time-series data.

Further details regarding implementation of change point determination according to various embodiments, are now provided in connection with the following example. This example collects time series data from tools available from SAP SE of Walldorf, Germany (“SAP”), to determine change points in order to analyze a number of records stored in a particular database table having a limited capacity.

### Example

The SAP S/4 HANA in-memory database has the capacity to handle very large volumes of data. Even SAP S/4 HANA, however, has limits as to an amount of data it is able to handle.

Accordingly, the SAP “2 Billion Record Limit” application, is part of the “Early WatchAlert (EWA) Workspace”. The 2 Billion Record Limit application predicts a date when a number of records stored in tables of SAP S/4HANA may exceed a limit of 2 billion (“2B”).

Upon reaching this 2B capacity, HANA tables are unable to store more records. No more inserts are possible, and HANA-dependent applications may crash-a highly undesirable result.

In order to avoid such an outcome, the data basis for the 2 Billion Record Limit application comprises many time series, one for each table, with a number of records value per week. Similar to the simple refrigerator/milk example described above, each time series is extrapolated and the time is calculated when the number of records is predicted to reach the 2 billion limit.

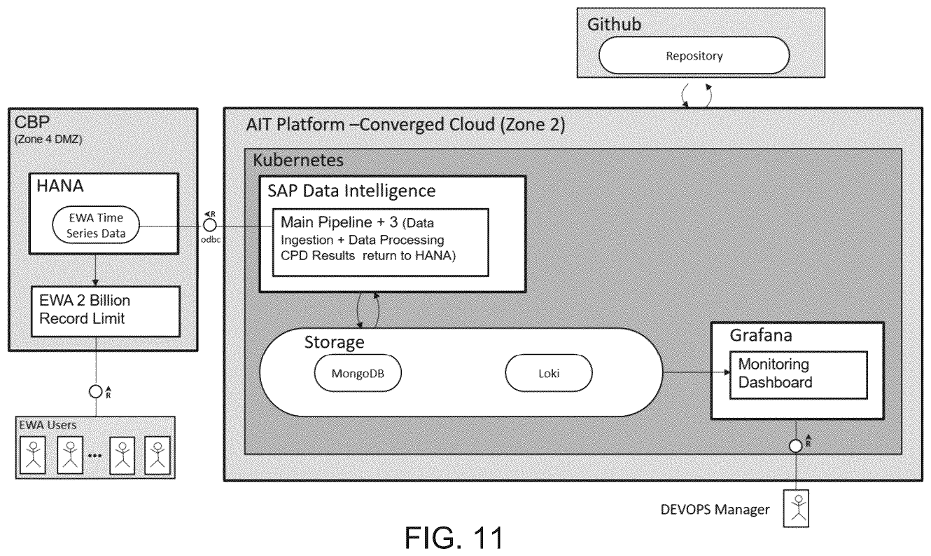

FIG. 11 shows a simplified architecture illustrating how change point determination could be implemented according to an example. The change point detection (CPD) is separated from the “2 billion” application, because different technologies are used:
2 billion: ABAP backend with UI5 frontend;
change points: SAP Data Intelligence (DI) with Python code

The change point detection reads time series data from the ABAP backend database, performs the detection and then the result is written back to the database. Here the backend is shown as the CB* System.

HANA Tables are used to store EWA Time Series Data for 2B Record Limit. CB* is the platform. Data is accessible to SAP Data Intelligence using ODBC connection. ABAP is used to Trigger forecast calculation and recalculation. HANA PAL library API version 2 is used to calculate a prediction.

FIG. 11 also shows the 2B Record Limit (EWA Workspace in SAP OneSupport Launchpad). This is used to show prediction of critical tables growth. Data is fetched from HANA over Odata requests. Different filters are available, and a manual recalculation button is also available.

There are various components of the AIT platform. The SAP Data Intelligence (DI) component of the CPD system comprises several sub components.
a main pipeline. This pipeline may run daily—it controls following sub pipeline: One data ingestion pipeline (fetched the data from HANA);
a data processing pipeline (format the data and runs CPD procedures)
a data return pipeline (write CPD Results back to HANA Tables).

MongoDB stores data to be processed by data processing pipeline. The Mongo DB comprises json Objects (collections) which represents the timeseries data of 2B record APP in formatted way.

Loki is used to store runtime logs and cluster logs. Grafana displays the runtime logs to the user in graphical panel.

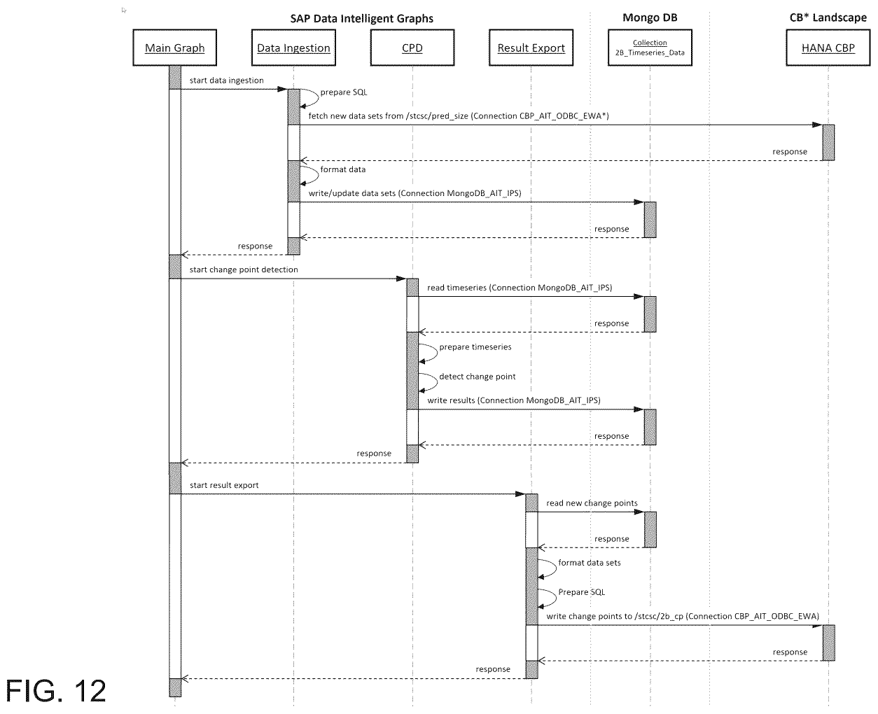

FIG. 12 shows a data flow and sequence diagram according to the example. The following are SAP DI connections and users.
CBP_AIT_ODC_EWA to HANA CBP uses HANA user with read and write authorization for specific EWA tables only.
MongoDB_AIT_IPS to MongoDB in Data Lake uses Mongo DB user with read and write authorization for EWA collections only

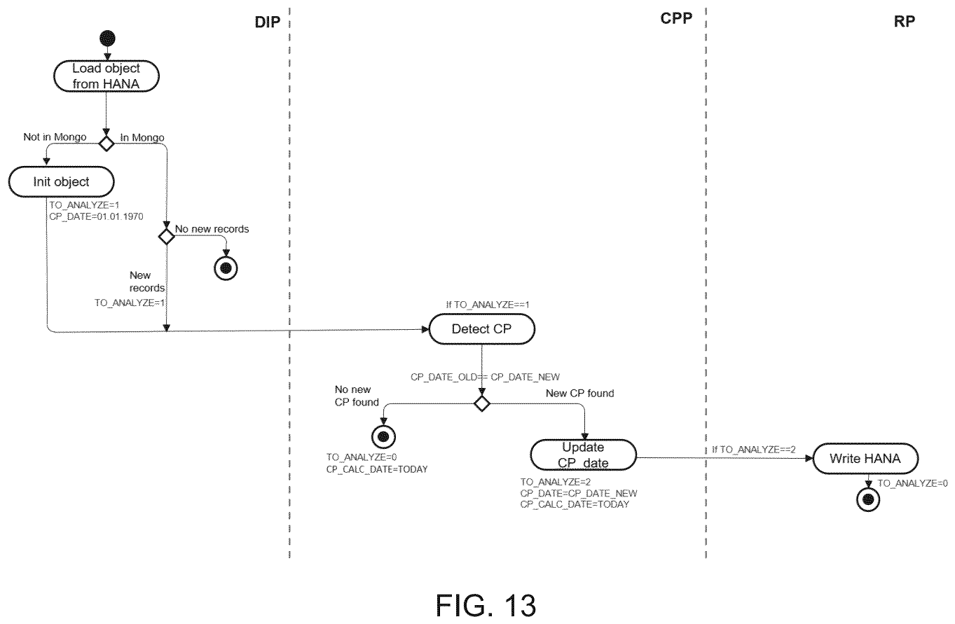

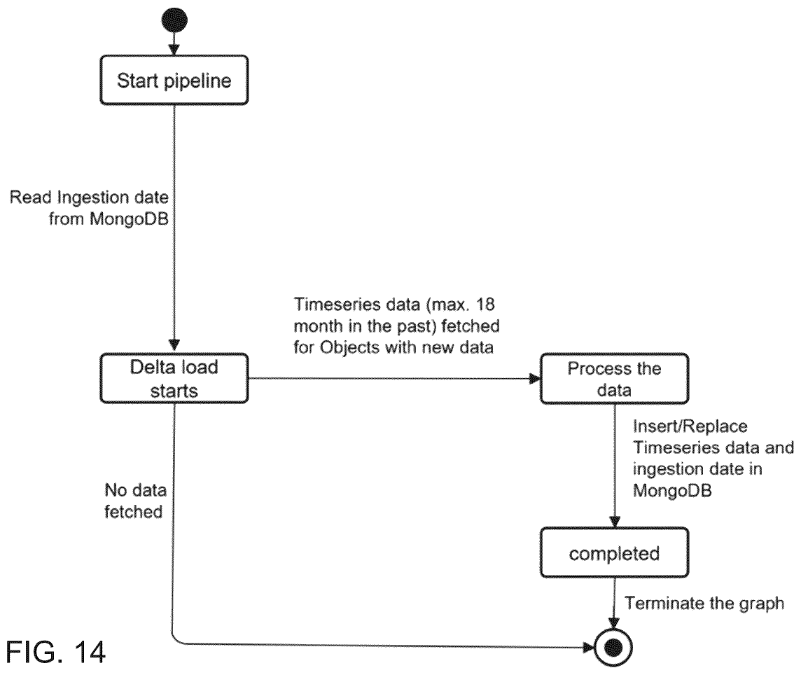

FIG. 13 shows an activity diagram for the example. FIG. 14 shows delta load state diagram according to the example.

EWA CPD according to this example may rely upon procedures and applied patterns. An objective of the change point detection is to split a time series into two parts. One part (on the “right” side of the determined change point) which can be used for a more accurate forecast. Another (“left”) part becomes irrelevant due to the change.

The procedure is to find change point candidates first (using analytical methods). Then, the most relevant changepoint determined by applying suitable rules.

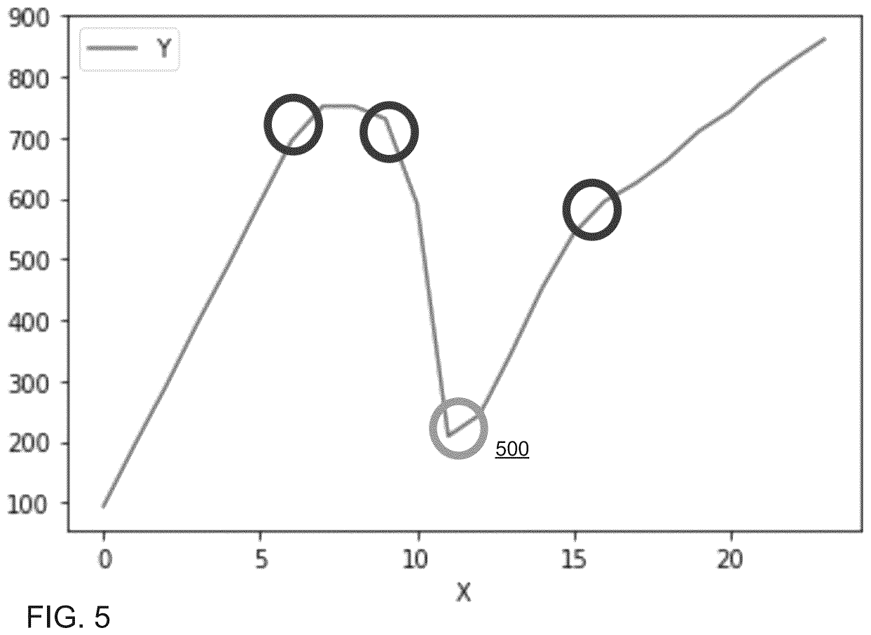

FIG. 5 shows an example. Potential change point candidates are marked with a circle. The most relevant one is shown as 500.

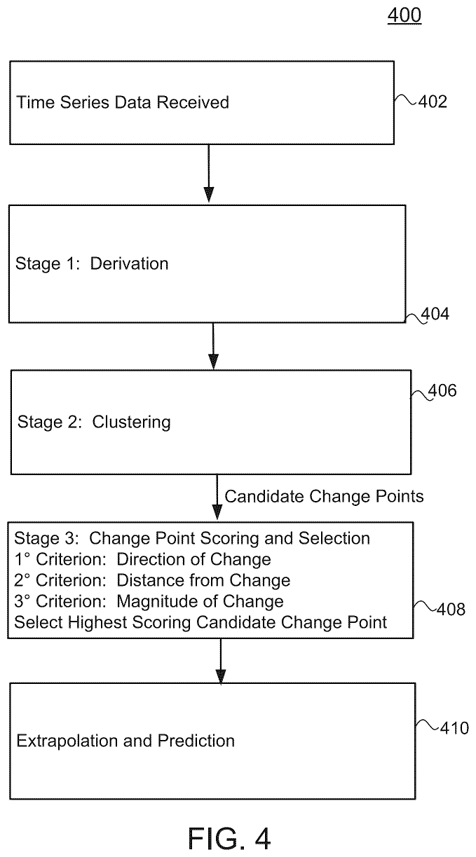

CPD in this example is summarized in the flow 400 of FIG. 4. At 402 time series data is received.

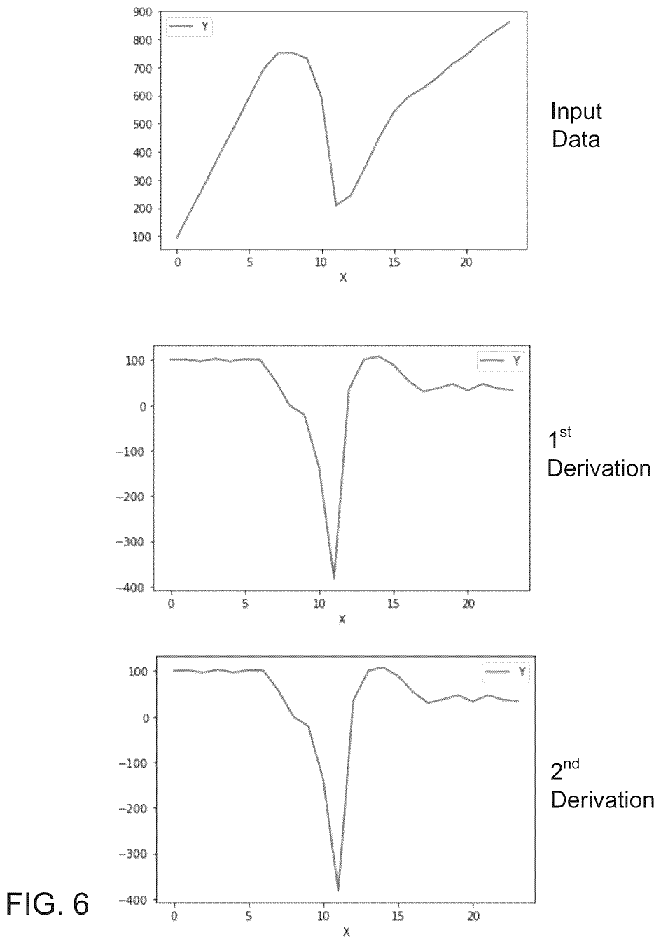

A first stage 404 of CPD according to this example involves derivation. One approach to find candidate change points, is to analyze the second derivation of the input time series, as shown in FIG. 6. Rarely-occurring values in the second derivation indicate a candidate change point.

The derivation can be simply done by calculating the difference between adjacent data points. To keep the length of the data array (makes the further processing easier), data point at beginning and end are simply duplicated.

A second stage of CPD according to embodiments involves clustering 406 to determine candidate change points. Clustering is used to find the “rare” values in the 2nd derivation. Small clusters contain the potential candidate change points.

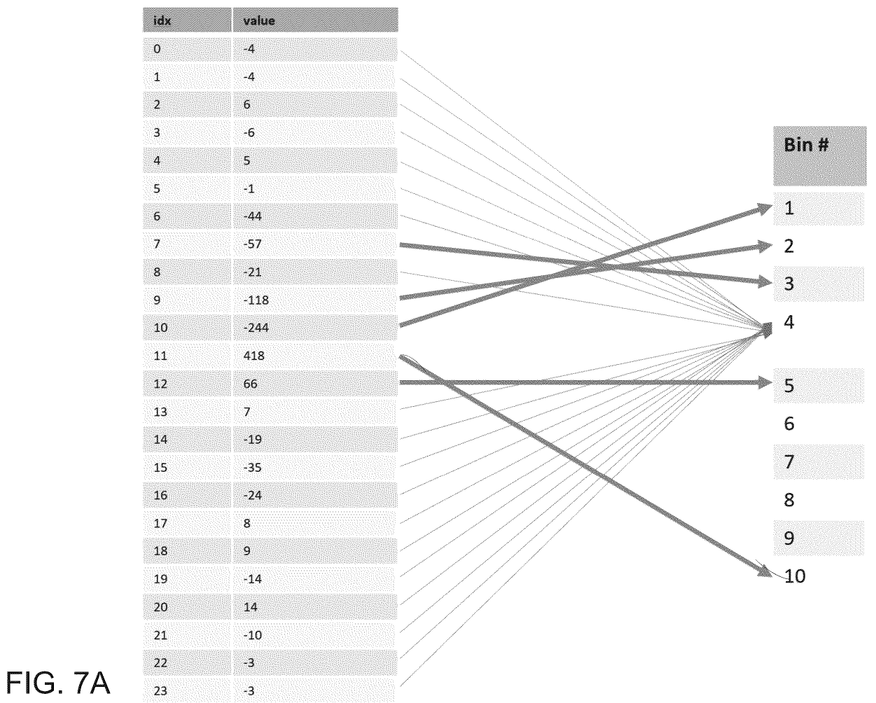

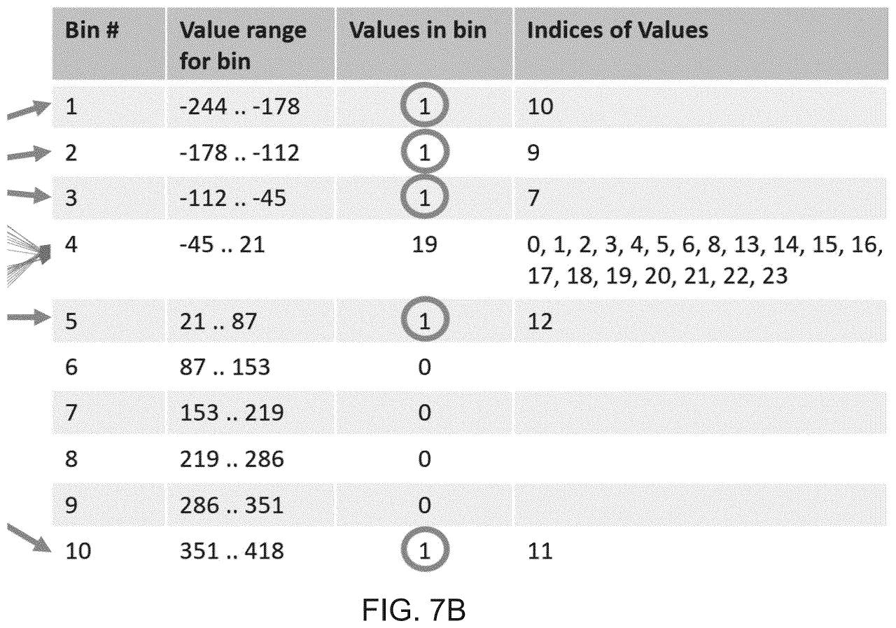

A simple “binning” is used for the clustering. The value range is split into N (default N=10) bins. The values are sorted into these bins. FIGS. 7A-B show a clustering approach.

Once candidate change points have been identified by clustering, the next stage is to calculate scores 408 for each of the candidate change points. This scoring utilizes criteria according to the following order of priority:
1° direction relative to trend
2° position in the time series
3° magnitude
   Comparison of the candidate change point having the highest score, reveals the determined change point.

Subsequent prediction/forecasting may be from the perspective of this change point. This can involve truncation to exclude time series data prior to the selected change point, followed by extrapolation.

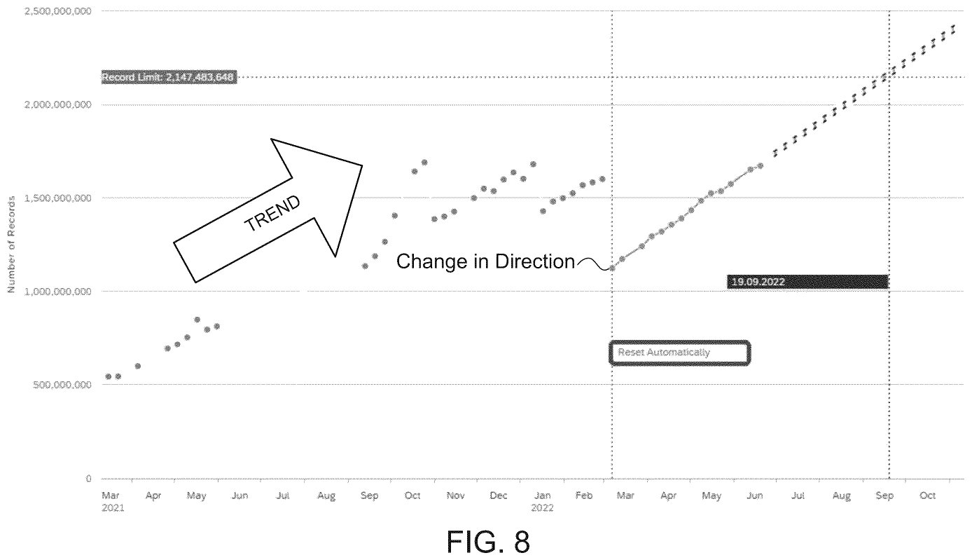

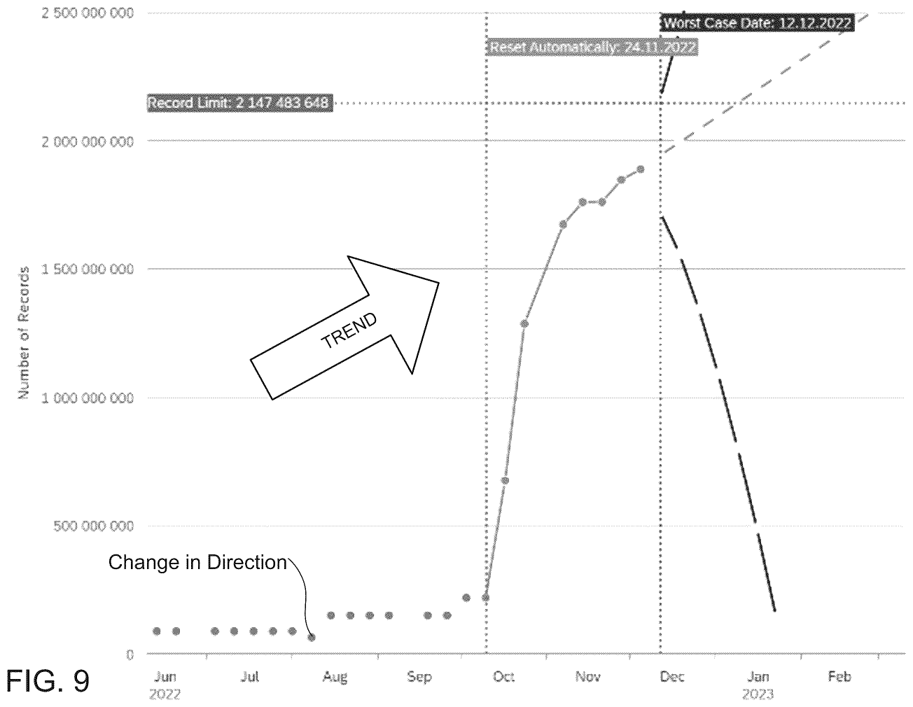

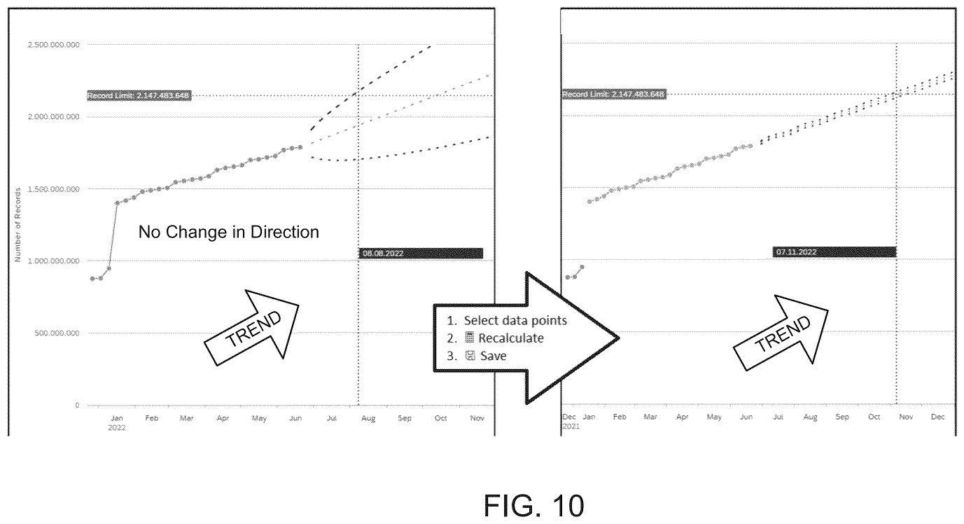

FIG. 8 shows a plot where the primary criterion (direction relative to trend) turns out to be dominant in determining the change point. FIG. 9 shows a plot where the secondary criterion (position) turns out to be dominant (over a change in direction) in determining the change point. FIG. 10 shows a plot where there is no change in direction, and the tertiary criterion (magnitude) turns out to be dominant to determine the change point.

While the above example specifically relates to determining a change point for database table volumes, embodiments are not limited to this or any particular application. Change point detection according to embodiments may be applied to many other types of time series data, for example a patient's health status such as heart rate, or speech recognition where change points are determined to identify segments between silence, sentences, words, and noise.

While FIG. 1 shows a particular embodiment with the change point engine as being located outside the database storing the time series data, this is not required. Rather, alternative embodiments could leverage the processing power of an in-memory database engine (e.g., the in-memory database engine of the HANA in-memory database available from SAP SE), in order to perform one or more various functions as described above.

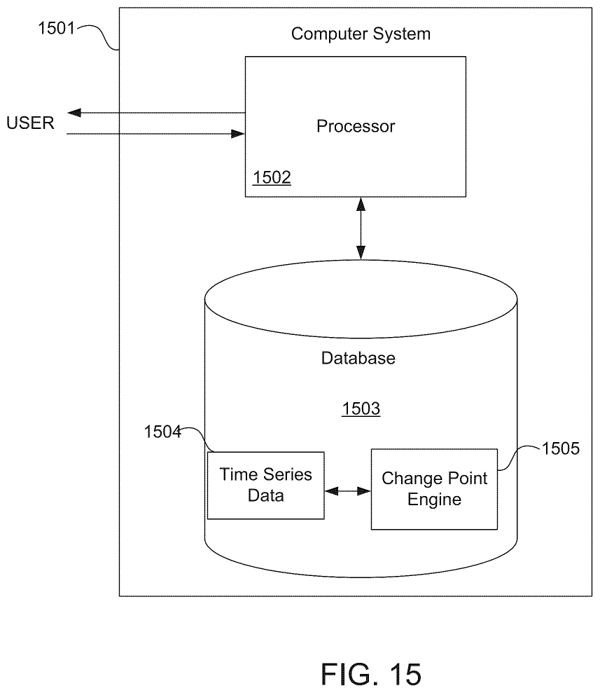

Thus FIG. 15 illustrates hardware of a special purpose computing machine configured to implement change point determination according to an embodiment. In particular, computer system 1501 comprises a processor 1502 that is in electronic communication with a non-transitory computer-readable storage medium comprising a database 1503. This computer-readable storage medium has stored thereon code 905 corresponding to a change point engine. Code 1504 corresponds to time series data. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented systems and methods comprising:
receiving time series data exhibiting a natural trend;
receiving a first candidate change point in the time series data, the first candidate change point comprising an earlier time and a first value;
receiving a second candidate change point in the time series data, the second candidate change point comprising a later time and a second value;
executing a rule upon the first candidate change point to calculate a first score, the rule comprising,
   a primary criterion for a change direction relative to the natural trend,
   a secondary criterion for a change position within the time series data, and
   a tertiary criterion for a change magnitude;
executing the rule upon the second candidate change point to calculate a second score;
comparing the first score to the second score to select the first candidate change point or the second candidate change point as a determined change point; and
storing the determined change point in a non-transitory computer readable storage medium.

Example 2. The computer implemented systems or methods of Example 1 wherein the rule comprises a first function to amplify an effect of the primary criterion.

Example 3. The computer implemented systems or methods of Examples 1 or 2 wherein the rule comprises a second function to reduce an effect of the secondary criterion.

Example 4. The computer implemented systems or methods of Examples 1, 2, or 3 wherein:
the rule comprises a first parameter for the primary criterion;
the rule comprises a second parameter for the secondary criterion;
the rule comprises a third parameter for the tertiary criterion; and
the system or method further comprises optimizing the first parameter, the second parameter, and the third parameter.

Example 5. The computer implemented systems or methods of Examples 1, 2, 3, or 4 wherein the first candidate change point and the second candidate change point are generated by derivation followed by clustering.

Example 6. The computer implemented systems or methods of Examples 1, 2, 3, 4, or 5 wherein:
the non-transitory computer readable medium comprises an in-memory database engine also storing the time series data; and
the rule is executed by an in-memory database engine of the in-memory database.

Example 7. The computer implemented systems or methods of Examples 1, 2, 3, 4, 5, or 6 further comprising referencing the determined change point to calculate a predicted outcome by excluding time series data preceding the determined change point.

Example 8. The computer implemented systems or methods of Example 7 wherein:
the natural trend comprises an increase, and the predicted outcome is a time that a capacity is reached; or
the natural trend comprises a decrease, and the predicted outcome is a time that a capacity is exhausted.

Example 9. The computer implemented systems or methods of Examples 7 or 8 wherein:
the non-transitory computer readable storage medium comprises an in-memory database also storing the time series data; and
an in-memory database engine of the in-memory database is configured to calculate the predicted outcome.

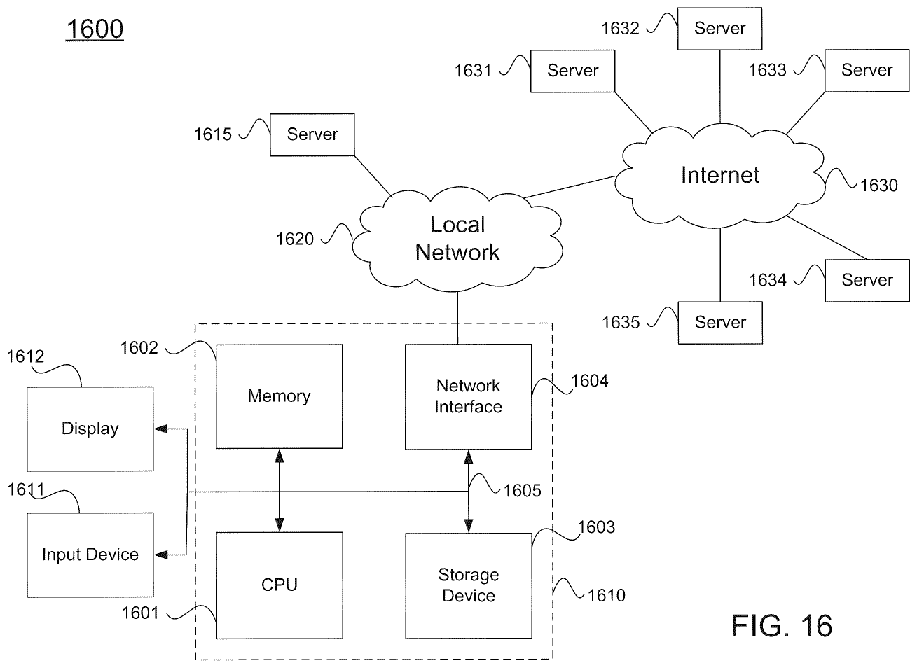

An example computer system 1600 is illustrated in FIG. 16. Computer system 1610 includes a bus 1605 or other communication mechanism for communicating information, and a processor 1601 coupled with bus 1605 for processing information. Computer system 1610 also includes a memory 1602 coupled to bus 1605 for storing information and instructions to be executed by processor 1601, including information and instructions for performing the techniques described above, for example. This memory may also be used for storing variables or other intermediate information during execution of instructions to be executed by processor 1601. Possible implementations of this memory may be, but are not limited to, random access memory (RAM), read only memory (ROM), or both. A storage device 1603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1603 may include source code, binary code, or software files for performing the techniques above, for example. Storage device and memory are both examples of computer readable mediums.

Computer system 1610 may be coupled via bus 1605 to a display 1612, such as a Light Emitting Diode (LED) or liquid crystal display (LCD), for displaying information to a computer user. An input device 1611 such as a keyboard and/or mouse is coupled to bus 1605 for communicating information and command selections from the user to processor 1601. The combination of these components allows the user to communicate with the system. In some systems, bus 1605 may be divided into multiple specialized buses.

Computer system 1610 also includes a network interface 1604 coupled with bus 1005. Network interface 1604 may provide two-way data communication between computer system 1610 and the local network 1620. The network interface 1604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1604 sends and receives electrical, electromagnetic, or optical signals that carry digital data streams representing various types of information.

Computer system 1610 can send and receive information, including messages or other interface actions, through the network interface 1604 across a local network 1620, an Intranet, or the Internet 1630. For a local network, computer system 1610 may communicate with a plurality of other computer machines, such as server 1615. Accordingly, computer system 1610 and server computer systems represented by server 1615 may form a cloud computing network, which may be programmed with processes described herein. In the Internet example, software components or services may reside on multiple different computer systems 1610 or servers 1631-1635 across the network. The processes described above may be implemented on one or more servers, for example. A server 1631 may transmit actions or messages from one component, through Internet 1630, local network 1620, and network interface 1604 to a component on computer system 1610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving time series data exhibiting a natural trend;
receiving a first candidate change point in the time series data, the first candidate change point comprising an earlier time and a first value;
receiving a second candidate change point in the time series data, the second candidate change point comprising a later time and a second value;
executing a rule upon the first candidate change point to calculate a first score, the rule comprising,
a primary criterion for a change direction relative to the natural trend,
a secondary criterion for a change position within the time series data, and
a tertiary criterion for a change magnitude;
executing the rule upon the second candidate change point to calculate a second score;
comparing the first score to the second score to select the first candidate change point or the second candidate change point as a determined change point; and
storing the determined change point in a non-transitory computer readable storage medium.

2. A method as in claim 1 wherein the rule comprises a first function to amplify an effect of the primary criterion.

3. A method as in claim 1 wherein the rule comprises a second function to reduce an effect of the secondary criterion.

4. A method as in claim 1 wherein:
the rule comprises a first parameter for the primary criterion;
the rule comprises a second parameter for the secondary criterion;
the rule comprises a third parameter for the tertiary criterion; and
the method further comprises optimizing the first parameter, the second parameter, and the third parameter.

5. A method as in claim 1 wherein the first candidate change point and the second candidate change point are generated by derivation followed by clustering.

6. A method as in claim 1 wherein:
the non-transitory computer readable medium comprises an in-memory database engine also storing the time series data; and
the rule is executed by an in-memory database engine of the in-memory database.

7. A method as in claim 1 further comprising:
referencing the determined change point to calculate a predicted outcome by excluding time series data preceding the determined change point.

8. A method as in claim 7 wherein:
the natural trend comprises an increase, and the predicted outcome is a time that a capacity is reached; or
the natural trend comprises a decrease, and the predicted outcome is a time that a capacity is exhausted.

9. A method as in claim 7 wherein:
the non-transitory computer readable storage medium comprises an in-memory database also storing the time series data; and
an in-memory database engine of the in-memory database is configured to calculate the predicted outcome.

10. A non-transitory computer readable storage medium embodying a computer program for performing a method, said method comprising:
receiving time series data having a natural trend comprising an increase to reach a capacity;
receiving a first candidate change point in the time series data, the first candidate change point comprising an earlier time and a first value;
receiving a second candidate change point in the time series data, the second candidate change point comprising a later time and a second value;
executing a rule upon the first candidate change point to calculate a first score, the rule comprising,
a primary criterion for a change direction relative to the natural trend,
a secondary criterion for a change position within the time series data, and
a tertiary criterion for a change magnitude;
executing the rule upon the second candidate change point to calculate a second score;
comparing the first score to the second score to select the first candidate change point or the second candidate change point as a determined change point; and
storing the determined change point in a non-transitory computer readable storage medium.

11. A non-transitory computer readable storage medium as in claim 10 wherein the rule comprises:
a first function to amplify an effect of the primary criterion; and
a second function to reduce an effect of the secondary criterion.

12. A non-transitory computer readable storage medium as in claim 10 wherein:
the rule comprises a first parameter for the primary criterion;
the rule comprises a second parameter for the secondary criterion;
the rule comprises a third parameter for the tertiary criterion; and
the method further comprises optimizing the first parameter, the second parameter, and the third parameter.

13. A non-transitory computer readable storage medium as in claim 10 wherein the first candidate change point and the second candidate change point are generated by derivation followed by clustering.

14. A non-transitory computer readable storage medium as in claim 10 wherein the method further comprises:
referencing the determined change point to calculate a predicted outcome by excluding time series data preceding the determined change point.

15. A computer system comprising:
one or more processors;
a software program, executable on said computer system, the software program configured to cause an in-memory database engine of an in-memory database to:
receive from the in-memory database, time series data exhibiting a natural trend;
receive a first candidate change point in the time series data, the first candidate change point comprising an earlier time and a first value;
receive a second candidate change point in the time series data, the second candidate change point comprising a later time and a second value;
execute a rule upon the first candidate change point to calculate a first score, the rule comprising,
a primary criterion for a change direction relative to the natural trend,
a secondary criterion for a change position within the time series data, and
a tertiary criterion for a change magnitude;
executing the rule upon the second candidate change point to calculate a second score;
compare the first score to the second score to select the first candidate change point or the second candidate change point as a determined change point; and
store the determined change point in the in-memory database.

16. A computer system in claim 15 wherein the rule comprises:
a first function to amplify an effect of the primary criterion; and
a second function to reduce an effect of the secondary criterion.

17. A computer system as in claim 15 wherein:
the rule comprises a first parameter for the primary criterion;
the rule comprises a second parameter for the secondary criterion;
the rule comprises a third parameter for the tertiary criterion; and
the in-memory database engine is further configured to optimize the first parameter, the second parameter, and the third parameter.

18. A computer system as in claim 15 wherein the in-memory database engine is further configured to generate the first candidate change point and the second candidate change point by derivation followed by clustering.

19. A computer system as in claim 15 wherein the in-memory database engine is further configured to reference the determined change point to calculate a predicted outcome by excluding time series data preceding the determined change point.

20. A computer system as in claim 19 wherein:
the natural trend comprises an increase and the predicted outcome is a time that a capacity is reached; or
the natural trend comprises a decrease and the predicted outcome is a time that a capacity is exhausted.
